(19) United States
(12) Patent Application Publication
(10) Pub. No.: US 2025/0362674 A1
(43) Pub. Date: Nov. 27, 2025

(54) REMOTE SUPPORT SYSTEM

(71) Applicant: TOYOTA JIDOSHA KABUSHIKI KAISHA, Toyota-shi (JP)

(72) Inventors: Ryo SHIRONO, Sunto-gun (JP); Takefumi GOTO, Gotemba-shi (JP); Hiromitsu URANO, Numazu-shi (JP)

(73) Assignee: TOYOTA JIDOSHA KABUSHIKI KAISHA, Toyota-shi (JP)

(21) Appl. No.: 19/087,727

(22) Filed: Mar. 24, 2025

(30) Foreign Application Priority Data
May 23, 2024 (JP) 2024-084202

(51) Int. Cl. G05D 1/224; G05D 109/10

(52) U.S. Cl. CPC G05D 1/2247; G05D 2109/10

(57) ABSTRACT

A remote support system includes one or more processors. The one or more processors are configured to: acquire a plurality of tasks which are obtained by being divided in accordance with content of remote support requested from an automated driving vehicle and an execution order of which is determined; and execute display processing of displaying one or more videos necessary for execution of the plurality of tasks on a remote support device operated by a remote supporter such that the remote supporter is caused to perform the plurality of tasks in accordance with the execution order.

### CROSS-REFERENCES TO RELATED APPLICATION

The present disclosure claims priority under 35 U.S.C. § 119 to Japanese Patent Application No. 2024-084202, filed on May 23, 2024, which is incorporated herein by reference in its entirety.

### BACKGROUND

### Technical Field

The present disclosure relates to a technique for remotely supporting an automated driving vehicle.

### Background Art

JP 2022-148824 A discloses a remote support system. The remote support system determines a recommended option of a combination of support processing and delegation processing based on a result database indicating a result of support request processing by an automated driving vehicle for each scene. Then, the remote support system presents the determined recommended option to an operator. The support processing is vehicle processing performed by the operator instead of the target automated driving vehicle. On the other hand, the delegation processing is processing that the operator delegates to the target automated driving vehicle.

Moreover, J P 2023-054400 A discloses a remote support server. When receiving requests for remote support from at least two vehicles in the same time zone, the remote support server organizes these vehicles into at least one group, determines a support order of the vehicles in the at least one group for each group, and transmits, in accordance with the support order, surrounding image information of the vehicles to at least one support device that performs the remote support of the vehicles organized into the at least one group.

### SUMMARY

It is desirable to further reduce the load on a remote supporter who performs remote support.

A remote support system according to the present disclosure includes one or more processors. The one or more processors are configured to: acquire a plurality of tasks which are obtained by being divided in accordance with content of remote support requested from an automated driving vehicle and an execution order of which is determined; and execute display processing of displaying one or more videos necessary for execution of the plurality of tasks on a remote support device operated by a remote supporter such that the remote supporter is caused to perform the plurality of tasks in accordance with the execution order.

According to the present disclosure, the remote supporter no longer have to determine in what order the remote support should be performed. Therefore, the load on the remote supporter can be reduced.

### BRIEF DESCRIPTION OF THE DRAWINGS

FIG. 1 is a conceptual diagram used to describe an overview of a remote support system according to an embodiment;

FIG. 2 is a flowchart illustrating an example of a flow of processing related to remote support according to an embodiment;

FIG. 3 is a diagram used to describe a first display example of display processing according to an embodiment;

FIG. 4 is a diagram used to describe a second display example of the display processing according to an embodiment;

FIG. 5 is a diagram used to describe a third display example of the display processing according to an embodiment;

FIG. 6 is a diagram used to described a fourth display example of the display processing according to an embodiment;

FIG. 7 is a flowchart illustrating an example of a flow of processing related to a first usage example of a degree of similarity according to an embodiment; and

FIG. 8 is a flowchart illustrating an example of a flow of processing related to a second usage example of the degree of similarity according to an embodiment.

### DETAILED DESCRIPTION

Embodiments of the present disclosure will be described with reference to the accompanying drawings.

### 1. Overview of Remote Support System

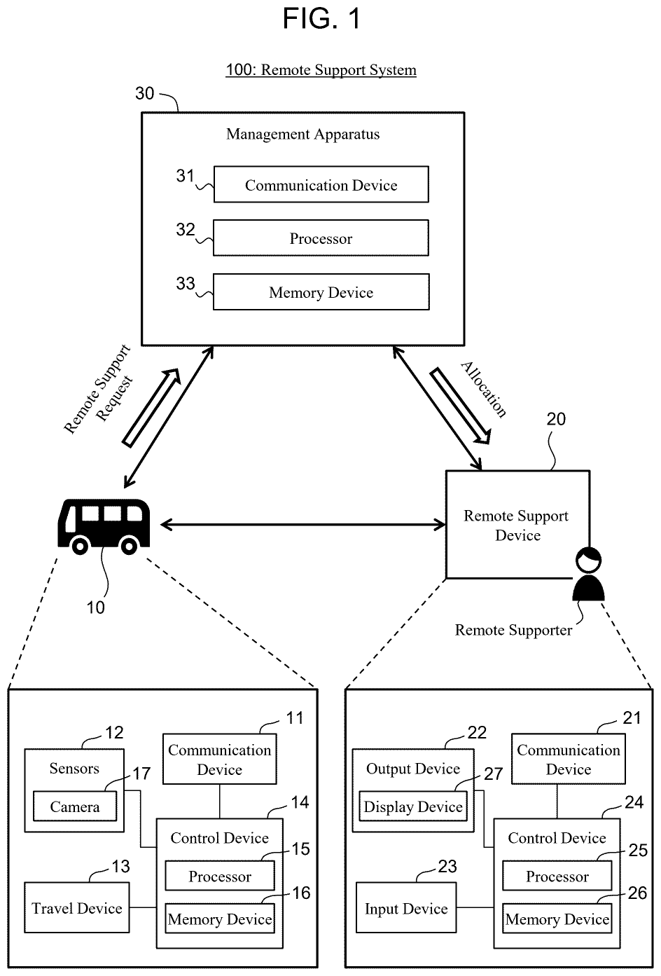

FIG. 1 is a conceptual diagram used to describe an overview of a remote support system 100 according to the present embodiment. The remote support system 100 is a system for remote support for an automated driving vehicle 10. The remote support system 100 includes the automated driving vehicle 10, a remote support device 20, and a management apparatus 30.

The automated driving vehicle 10 (hereinafter, simply referred to as a vehicle 10) has, for example, an automated driving function of level 4 or higher which does not require a driver. The vehicle 10 may be, for example, an automated driving bus configured to operate in a limited area. The vehicle 10 communicates with the management apparatus 30 and requests remote support as necessary. In response to this remote support request, the remote support system 100 remotely supports the vehicle 10. More specifically, a remote supporter (operator) who is a human remotely supports the vehicle 10 via the remote support device 20. The remote support system 100 can also be said to be a system that assists the remote support of the automated driving vehicle 10 by the remote supporter.

The remote support device 20 is a terminal device operated by the remote supporter when the remote supporter remotely supports the vehicle 10. That is, the remote support device 20 is configured to be used by the remote supporter for the remote support of the automated driving vehicle 10. The remote support device 20 includes a display device 27. The display device 27 displays information, such as the situation of an area in which the vehicle 10 travels and the position and state of the vehicle 10. The remote supporter monitors the information displayed on the display device 27. Then, the remote supporter remotely supports the vehicle 10 as necessary.

The remote support includes remote support (traveling support) related to traveling of the vehicle 10 and remote support (service support) related to a service provided by the vehicle 10.

The situation in which the traveling support by the remote supporter is necessary is, for example, a situation in which the automated driving is difficult. The vehicle 10 executes various kinds of vehicle processing during the execution of the automated driving. Examples of the vehicle processing include “recognition processing”, “action determination processing”, and “timing determination processing”. To be specific, in the recognition processing, the vehicle 10 recognizes a situation around the vehicle 10 using one or more recognition sensors. For example, the vehicle 10 recognizes a signal display of a traffic light (for example, a green light, a yellow light, a red light, or a right turn signal) using a camera. In the action determination processing, the vehicle 10 determines whether or not to execute an action based on the result of the recognition processing. Examples of the action of the vehicle 10 include starting, stopping, turning right, turning left, and changing lanes. In the timing determination processing, the vehicle 10 determines an execution timing at which the action is executed.

The traveling support is support related to each of various kinds of vehicle processing described above. For example, when a traffic light installed at an intersection is exposed to sunlight, the accuracy of recognition of a signal display may be reduced. When the signal display cannot be accurately determined by the recognition processing, the vehicle 10 needs the remote support for the signal recognition by the remote supporter. Thus, “support for recognition of a signal display of a traffic light” corresponds to an example of the traveling support. In addition, when the signal display cannot be determined, it is also difficult to determine what action should be executed at what timing. Therefore, the vehicle 10 also needs the remote support by the remote supporter for the action determination processing and the timing determination processing. Thus, “support for determination of the starting (Go/Not Go) and support for determination of timing of the starting” also correspond to examples of the traveling support.

In an example in which the vehicle 10 equipped with a door through which a passenger gets on and off provides a service of automatically opening and closing the door to the passenger, “support for determination of opening and closing of the door and determination of opening and closing timing” correspond to examples of the service support by the remote supporter. Furthermore, in an example in which the automated driving vehicle 10 provides a service of checking safety in the vehicle 10 to the passenger, “support for checking safety in the vehicle 10” corresponds to an example of the service support.

The management apparatus 30 manages the remote support system 100. The management apparatus 30 may be configured by a plurality of servers that perform distributed processing. The management apparatus 30 manages a plurality of remote supporters and a plurality of remote support devices 20. For example, in response to a remote support request from the vehicle 10, the management apparatus 30 allocates one remote supporter and one remote support device 20 to the remote support of the vehicle 10. Alternatively, the management apparatus 30 may allocate a plurality of remote supporters and a plurality of remote support devices 20 for the remote support of one vehicle 10. Further, in order to collectively remotely support a plurality of vehicles 10, the management apparatus 30 may allocate a plurality of remote supporters and a plurality of remote support devices 20 to the remote support of the plurality of vehicles 10.

When the remote support by the remote supporter is necessary, the vehicle 10 transmits to the management apparatus 30, a “support request information REQ” indicating a request for the remote support. The management apparatus 30 receives the support request information REQ from the automated driving vehicle 10. The support request information REQ includes the content of the remote support requested from the vehicle 10.

The management apparatus 30 notifies the remote supporter of the received support request information REQ through the remote support device 20 and requests the remote supporter to give an instruction INS to the vehicle 10. The remote supporter determines the instruction INS to the vehicle 10 in accordance with the content of the remote support included in the support request information REQ. More specifically, when the remote support is performed, the remote support device 20 displays on the display device 27, a video V captured by a camera 17 mounted on the vehicle 10 as a target of the remote support. The remote supporter views the video V displayed on the display device 27 and determines the instruction INS to the vehicle 10. The remote supporter inputs the instruction INS to the remote support device 20. The remote support device 20 (or the management apparatus 30) communicates with the automated driving vehicle 10 and notifies the vehicle 10 of the instruction INS from the remote supporter.

The vehicle 10 receives the instruction INS of the remote supporter from the remote support device 20 (or the management apparatus 30). Then, in accordance with the instruction INS, the vehicle 10 performs traveling (i.e., automated driving) or performs a service, such as opening and closing of a door.

In addition, the video V used for the remote support is transmitted from the vehicle 10 to, for example, the management apparatus 30 in real time through a communication. The transmitted image information is forwarded from the management apparatus 30 to the remote support device 20. Alternatively, the video V may be directly transmitted from the vehicle 10 to the remote support device 20.

### 2. Configuration Example

### 2-1. Automated Driving Vehicle

The vehicle 10 includes a communication device 11, sensors 12, a travel device 13, and a control device 14. The communication device 11 performs wireless communication with the outside of the vehicle 10. For example, the communication device 11 performs the wireless communication with the remote support device 20 and the management apparatus 30.

The sensors 12 include, for example, a recognition sensor, a vehicle state sensor, and a position sensor. The recognition sensor recognizes (detects) a situation around the vehicle 10. The recognition sensor includes one or more cameras 17 (hereinafter, simply referred to as a camera 17) that capture a plurality of surrounding situations of the vehicle 10. The vehicle state sensor detects a state (for example, a speed, an acceleration, a yaw rate, and a steering angle) of the vehicle 10. The position sensor detects a position and an orientation of the vehicle 10.

The travel device 13 includes a steering device, a drive device, and a brake device. The steering device steers a wheel of the vehicle 10. The drive device is a power source that generates a driving force of the vehicle 10, and includes, for example, at least one of an electric motor and an internal combustion engine. The brake device generates a braking force.

The control device 14 is configured to control the vehicle 10. The control device 14 includes one or more processors 15 (hereinafter, simply referred to as a processor 15) and one or more memory devices 16 (hereinafter, simply referred to as a memory device 16). The processor 15 executes various kinds of processing including processing related to the control of the vehicle 10. Examples of the processor 15 include a central processing unit (CPU), a graphics processing unit (GPU), an application specific integrated circuit (ASIC), and a field-programmable gate array (FPGA). The memory device 16 stores various kinds of information. Examples of the memory device 16 include a volatile memory, a nonvolatile memory, a hard disk drive (HDD), and a solid state drive (SSD). The function of the control device 14 may be implemented by cooperation of the processor 15 (processing circuit) that executes a computer program and the memory device 16. The computer program is stored in the memory device 16. Alternatively, the computer program may be recorded in a non-transitory computer-readable recording medium or may be provided via a network.

### 2-2. Remote Support Device

The remote support device 20 includes a communication device 21, an output device 22, an input device 23, and a control device 24.

The communication device 21 communicates with the vehicle 10 and the management apparatus 30. The output device 22 outputs various kinds of information. The output device 22 includes a display device 27. The display device 27 includes one or more monitors and displays various kinds of information to the remote supporter. The output device 22 may include a speaker. The input device 23 receives an input from the remote supporter. Examples of the input device 23 include a touch panel, a keyboard, and a mouse.

The control device 24 is configured to control the remote support device 20. The control device 24 includes one or more processors 25 (hereinafter, simply referred to as a processor 25) and one or more memory devices 26 (hereinafter, simply referred to as a memory device 26). The processor 25 executes various kinds of processing. Examples of the processor 25 include a CPU, a GPU, an ASIC, and an FPGA. The memory device 26 stores various kinds of information. Examples of the memory device 26 include a volatile memory, a nonvolatile memory, an HDD, and an SSD. The function of the control device 24 may be implemented by cooperation of the processor 25 (processing circuit) that executes a computer program and the memory device 26. The computer program is stored in the memory device 26. Alternatively, the computer program may be recorded in a non-transitory computer-readable recording medium or may be provided via a network.

### 2-3. Management Apparatus

The management apparatus 30 includes a communication device 31, one or more processors 32 (hereinafter, simply referred to as a processor 32), and one or more memory devices 33 (hereinafter, simply referred to as a memory device 33). The communication device 31 communicates with the vehicle 10 and the remote support device 20.

The processor 32 executes various kinds of processing. Examples of the processor 32 include a CPU, a GPU, an ASIC, and an FPGA. The memory device 33 stores various kinds of information. Examples of the memory device 33 include a volatile memory, a nonvolatile memory, an HDD, and an SSD. The functions of the management apparatus 30 may be implemented by cooperation between the processor 32 (processing circuit) that executes a computer program and the memory device 33. The computer program is stored in the memory device 33. Alternatively, the computer program may be recorded in a non-transitory computer-readable recording medium or may be provided via a network.

### 3. Details of Remote Support

In the remote support, the remote supporter may be needed to make a determination in consideration of a plurality of elements. In other words, the remote support may have a plurality of confirmation items. For example, in the remote support of the operation of closing a door, the remote supporter needs to confirm that a passenger is not present near the door by viewing a video V indicating the inside of the vehicle 10 and confirm that a pedestrian is not about to get in the vehicle 10 by viewing a video V indicating the outside of the vehicle 10. In addition, when the number of items that need to be confirmed by the remote supporter increases, the load on the remote supporter increases. Therefore, it is desirable to reduce the load on the remote supporter needed for confirming the plurality of confirmation items.

Accordingly, in the present embodiment, the remote support system 100 acquires a plurality of tasks T (in other words, a plurality of confirmation items) which are obtained by being divided in accordance with the content of the remote support requested from the vehicle 10 and an execution order O of which is determined. Then, the remote support system 100 executes “display processing”. The display processing is executed to display one or more videos V necessary for the execution of the plurality of tasks T on the remote support device 20 such that the remote supporter is caused to perform the plurality of tasks T in accordance with the execution order O.

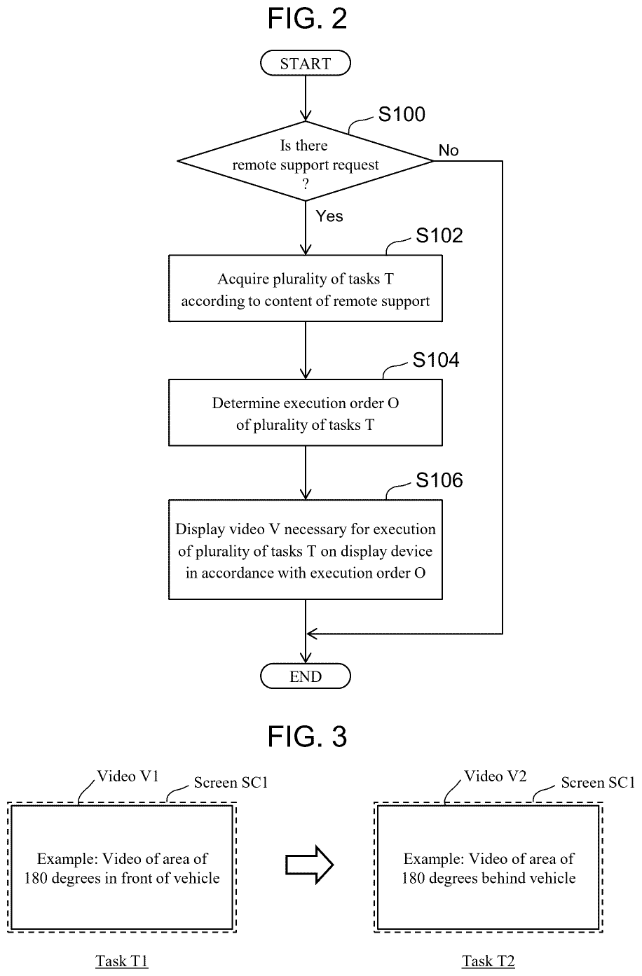

FIG. 2 is a flowchart illustrating an example of a flow of processing related to the remote support according to the present embodiment. The processing of this flowchart is executed by, for example, the management apparatus 30 (processor 32) and the remote support device 20 (processor 25) in cooperation with each other.

In step S100, the management apparatus 30 determines whether or not there is a remote support request from the vehicle 10 (more specifically, whether or not the support request information REQ has been received). As a result, when the support request information REQ is not received (step S100; No), the processing proceeds to END. On the other hand, when the support request information REQ has been received (step S100; Yes), the processing proceeds to step S102.

In step S102, the management apparatus 30 executes processing of acquiring a plurality of tasks T according to the content of remote support included in the received support request information REQ. For example, in the remote support for the operation of closing a door, “a task T1 for confirming that no passenger is present near the door” and “a task T2 for confirming that no walker is about to get in the vehicle 10” are acquired as the plurality of tasks T.

First and second examples of a method of dividing (i.e., converting) the content of remote support into the plurality of tasks T will be described in order. In the first example, the management apparatus 30 uses a task database to acquire a plurality of tasks T. The task database indicates a correspondence (i.e., combination) between the contents of a plurality of predetermined types of remote support and a plurality of types of tasks T, and is stored in, for example, the memory device 33. The management apparatus 30 acquires the plurality of tasks T associated with the content of the remote support (i.e., scene) included in the current support request information REQ by referring to the task database. This division method is suitable for an example where the content of remote support which is requested to the remote supporter is determined in advance to some extent.

In the second example, the management apparatus 30 uses a machine learning model to acquire a plurality of tasks T. This machine learning model is learned so as to output a plurality of tasks T corresponding to the input content of remote support. The machine learning model is stored in, for example, the memory device 33. The management apparatus 30 acquires the plurality of tasks T corresponding to the content of the remote support included in the current support request information REQ by inputting the content to the machine learning model.

In addition, unlike the processing illustrated in FIG. 2, the control device 14 (processor 15) of the vehicle 10 may execute the processing of acquiring the plurality of tasks T instead of the management apparatus 30. More specifically, the control device 14 may acquire a plurality of tasks using the division method described above and transmit the support request information REQ including information on the acquired plurality of tasks T to the management apparatus 30. Moreover, when the control device 14 acquires a plurality of tasks T, the control device 14 may acquire the plurality of tasks T such that the task T by the remote supporter does not include one or more items that can be determined (confirmed) on the side of the vehicle 10. This makes it possible to achieve more efficient remote support.

In step S104, the management apparatus 30 executes processing of acquiring the execution order O of the plurality of tasks T acquired in step S102. First and second examples of the method of determining the execution order O will be described below in order.

In the first example, the management apparatus 30 uses an execution order database to determine the execution order O. The execution order database indicates a correspondence (i.e., combination) between a plurality of predetermined types of tasks T and a plurality of types of execution orders O, and is stored in the memory device 33, for example. The management apparatus 30 acquires the execution order O associated with the plurality of tasks T acquired in step S102 by referring to the execution order database.

More specifically, the execution order database may be configured such that, for example, the execution order O of a task T having a narrow range to be viewed by the remote supporter is earlier. For example, the range to be viewed by the remote supporter when determining the color of a traffic signal is narrower than that when determining the presence or absence of a pedestrian, and the range to be viewed by the remote supporter when determining the presence or absence of a pedestrian is narrower than that when determining the presence or absence of an oncoming vehicle. Accordingly, the execution order O may be determined such that the task T of determining the color of a traffic light is the earliest, followed by the task T of determining the presence or absence of a pedestrian and the task T of determining the presence or absence of an oncoming vehicle in this order. Moreover, in an example of the remote support for checking the presence or absence of vehicles in front of and behind the vehicle 10 as the target of the remote support, the range to be viewed is narrower in the front than in the rear of the vehicle 10. Accordingly, the execution order O of the task T for checking the front may be advanced more than the execution order O of the task T for checking the rear.

Furthermore, the execution order database may be configured such that, for example, the execution order O of the task T in which a surrounding situation ST to be determined in the task T is less likely to change with a lapse of time is earlier than the execution order O of the task T in which the surrounding situation ST is more likely to change with a lapse of time. This makes it possible to appropriately reduce re-execution of the task T, which will be described below in Section 4-1.

In the second example, the management apparatus 30 uses a machine learning model to determine the execution order O. This machine learning model is learned so as to output an execution order O for a plurality of input tasks T. The machine learning model is stored in, for example, the memory device 33. The management apparatus 30 inputs the plurality of tasks T acquired in step S102 to the machine learning model to acquire the execution order O of the plurality of tasks T.

In addition, unlike the processing illustrated in FIG. 2, the control device 14 (processor 15) may execute the processing of determining the execution order O instead of the management apparatus 30. More specifically, the control device 14 may determine the execution order O by using the determination method described above, and may transmit to the management apparatus 30, the support request information REQ including information on the plurality of tasks T whose execution order O is determined.

In step S106 subsequent to step S104, the remote support device 20 (processor 25) executes the “display processing” described above. To be specific, as described above, during the remote support, one or more videos V captured by the camera 17 of the vehicle 10 as the target of the remote support are displayed on the display device 27 of the remote support device 20. The remote support device 20 receives, from the management apparatus 30, information on the plurality of tasks T whose execution order O is determined. Then, in the display processing, the remote support device 20 displays one or more videos V necessary for the execution of the plurality of tasks T on the display device 27 such that the remote supporter is caused to perform the plurality of tasks T in accordance with the execution order O. Hereinafter, first to fourth display examples of the display processing will be described in order.

### First Display Example

FIG. 3 is a diagram used to describe a first display example of the display processing according to the present embodiment. In the first display example, the remote support device 20 displays a plurality of videos V one by one at a designated position P on a screen SC1 of the display device 27 in accordance with the execution order O. In the first display example, the entire screen SC1 corresponds to a “designated position P” according to the present disclosure.

To be specific, FIG. 3 illustrates an example of two videos V1 and V2 respectively necessary for the execution of two tasks T1 and T2 (execution order O: V1→V2). In one example, the content of the remote support is “support for starting the vehicle 10 from a stopped state”, the task T1 is “checking that there is no stopped vehicle in front of the vehicle 10”, and the task T2 is “checking that there is no overtaking vehicle behind the vehicle 10”. The video V1 is a video image of the camera 17 that captures an area of 180 degrees in front of the vehicle 10, and the video V2 is a video image of another camera 17 that captures an area of 180 degrees behind the vehicle 10.

As illustrated in FIG. 3, the remote support device 20 first displays the video V1 on the screen SC1 in accordance with the execution order O. That is, the remote support devices 20 request the remote supporter to respond (answer) to the task T1. When the remote supporter who has viewed the video V1 confirms that “there is no stopped vehicle in front of the vehicle 10”, the remote supporter operates the input device 23 to give a positive answer indicating that the task T1 has been completed. The remote support device 20 that has received the response switches the video V displayed on the screen SC1 from the video V1 to the video V2. In other words, an imaging direction of the video V that is a direction in which the video V is captured is switched. When the remote supporter who has viewed the video V2 confirms that “there is no overtaking vehicle behind the vehicle 10”, the remote supporter operates the input device 23 to give a positive answer indicating that the task T2 has been completed. This corresponds to the completion of all the tasks T1 and T2, that is, that the remote supporter has given an instruction to start the vehicle 10. Therefore, the remote support device 20 (or the management apparatus 30) that has received the response notifies the vehicle 10 of the instruction (corresponding to the instruction INS described above) from the remote supporter. Thus, the remote support is completed.

Further, FIG. 3 illustrates an example in which one remote supporter performs remote support and a plurality of videos V (for example, V1 and V2) are displayed on the same screen SC1 of one remote support device 20 operated by the remote supporter. However, the first display example may be applied to remote support in which a plurality of remote supporters who operate a plurality of remote support devices 20 share a plurality of tasks T. More specifically, for example, every time one task T is completed, the video V for the next task T may be displayed on the screen of the remote support device 20 operated by the next remote supporter in charge of the next task T in accordance with the execution order O.

### Second Display Example

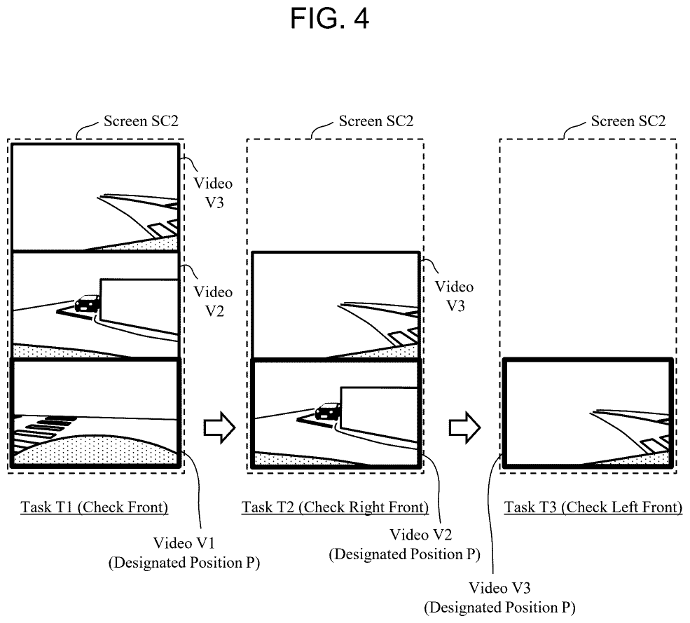

FIG. 4 is a diagram used to describe a second display example of the display processing according to the present embodiment. Even in the second display example, the remote support device 20 displays a plurality of videos V one by one at a designated position P on a screen SC2 of the display device 27 in accordance with the execution order O. However, the second display example is different from the first display example in the following points.

That is, in the second display example, the display device 27 has the screen SC2 that displays three videos V1 to V3. As shown in FIG. 4, the screen SC2 can display the videos V1 to V3 arranged along the vertical direction (i.e., the up-down direction of the paper surface). The screen SC2 may be configured by one monitor or may be configured by a plurality of monitors. In addition, in the second display example, the video position in the lowermost stage of the screen SC2 corresponds to the “designated position P” according to the present disclosure.

As illustrated in FIG. 4, the remote support device 20 first displays the video V1 (for example, a vehicle front video) for a task T1 (for example, Checking the Front) at the designated position P on the screen SC2 in accordance with the execution order O. When the task T1 is completed, the remote support device 20 displays the video V2 (for example, a vehicle right front video) for a task T2 (for example, Checking the Right Front) at the designated position P. More specifically, the video V1 is not displayed, and the videos V2 and V3 move downward. When the task T2 is completed, the remote support device 20 displays the video V3 (for example, a vehicle left front video) for a task T3 (for example, Checking the Left Front) at the designated position P. More specifically, the video V2 is not displayed, and the video V3 moves downward. As described above, in the second display example, the videos V1 to V3 of the three cameras 17 having different imaging directions are displayed one by one at the designated position P in accordance with the execution order O.

### Third Display Example

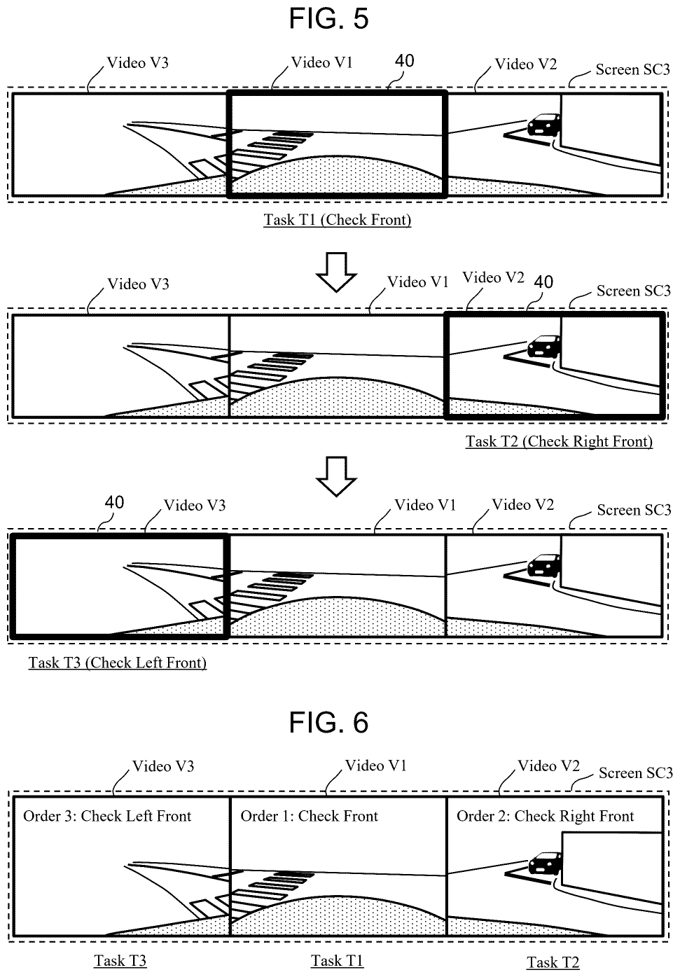

FIG. 5 is a diagram used to describe a third display example of the display processing according to the present embodiment. In the third display example, the remote support device 20 displays an auxiliary display indicating the execution order O on a screen SC3 of the display device 27.

To be specific, the display device 27 has the screen SC3 that displays three videos V1 to V3 arranged horizontally (in the left-right direction of the paper surface) as shown in FIG. 5. The videos V1 to V3 are the same as those illustrated in FIG. 4. The screen SC3 may be configured by one monitor or may be configured by a plurality of monitors. In addition, in the third display example, a highlighted display of a frame 40 surrounding the individual videos V1 to V3 is used as the auxiliary display indicating the execution order O.

As illustrated in FIG. 5, the remote support device 20 first highlights the frame 40 surrounding the video V1 (for example, a vehicle front video) for a task T1 (for example, Checking the Front) in accordance with the execution order O. When the task T1 is completed, the remote support device 20 highlights the frame 40 surrounding the video V2 (for example, a vehicle right front video) for a task T2 (for example, Checking the Right Front). When the task T2 is completed, the remote support device 20 highlights the frame 40 surrounding the video V3 (for example, a vehicle left front video) for a task T3 (for example, Checking the Left Front). As described above, in the third display example, on the screen SC3 on which the plurality of videos V (for example, V1 to V3) are displayed side by side during the execution of the plurality of tasks T, the frame 40 surrounding the video V corresponding to the task T to be executed in order is highlighted.

In addition, the highlighting of the frame 40 as the auxiliary display may be performed using a color that attracts attention, such as red. The highlighting may be performed by blinking the frame 40 a designated number of times.

### Fourth Display Example

FIG. 6 is a diagram used to described a fourth display example of the display processing according to the present embodiment. Even in the fourth display example, the remote support device 20 displays the auxiliary display indicating the execution order O on the screen SC3 of the display device 27. However, the auxiliary display in the fourth display example is a display of a short message (at least one of letters and numbers) indicating the execution order O. The short messages are, for example, the order 1, the order 2, and the order 3, and are directly displayed on the screen SC3 together with the videos V1 to V3. Further, as illustrated in FIG. 6, the short message may be displayed in combination with a message indicating the contents of the tasks T1 to T3 (for example, Checking the Front, Checking Right Front, and Checking the Left Front). In addition, for example, a short message, such as the order 1, may be displayed larger than a message indicating the contents of the tasks T1 to T3.

Furthermore, the display of the short message as the auxiliary display may be applied to an example of remote support in which only one video V is displayed on the screen of the display device 27 as a video necessary for the execution of a plurality of tasks T. More specifically, a combination of a short message (for example, order 1, order 2, and so on) indicating the execution order O and a message indicating the content of the task T may be displayed on the screen together with one video V for each task T.

According to the remote support system 100 described above, the remote supporter no longer have to determine in what order the remote support should be performed. Therefore, the load on the remote supporter can be reduced. More specifically, according to the plurality of tasks T which are obtained by being divided in accordance with the content of the remote support and the execution order O of which is determined as described above, the remote support which needs complicated situation determination can be expressed in a plurality of simple determination elements (i.e., confirmation items). The remote supporter only needs to execute such a plurality of tasks T in order in accordance with the display of the remote support device 20 (display device 27). Therefore, the load on the remote supporter is appropriately reduced.

### 4. Use of Degree of Similarity of Surrounding Situation

### 4-1. Determination of Necessity of Re-Execution of Task

In the above-described remote support in which a plurality of tasks T are executed one by one in accordance with the determined execution order O, it is desirable to appropriately consider the temporal validity (i.e., valid period of time) of a positive answer (i.e., determination result) regarding a task T completed at an early stage during execution of the remote support. The reason is that the surrounding situation ST of the vehicle 10, which is a determination target in the task T completed at an early stage, may change before all of the plurality of tasks T in the remote support are completed.

Accordingly, in the remote support, the remote support system 100 may additionally execute processing of using the degree of similarity DS as in the following first and second usage examples. Specifically, the plurality of videos V are related to a plurality of surrounding situations ST of the vehicle 10 captured by the camera 17. Each of the plurality of tasks T is for requesting the remote supporter to make a determination on one surrounding situation ST included in the plurality of surrounding situations ST. The degree of similarity DS mentioned here corresponds to the degree of similarity of the video V of the surrounding situation ST (in other words, the degree of change in the surrounding situation ST).

### First Usage Example

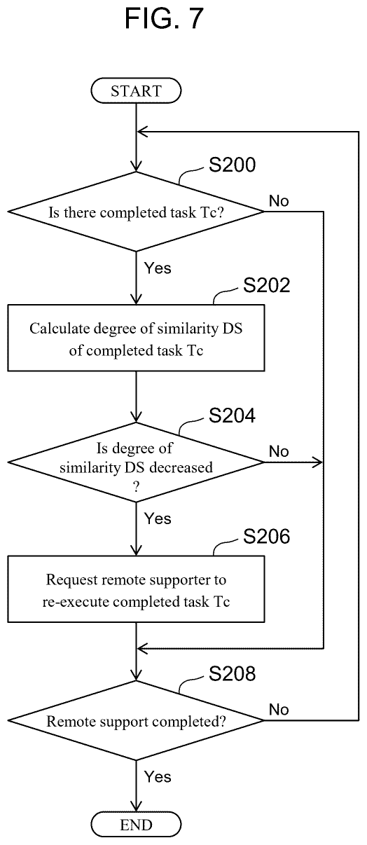

FIG. 7 is a flowchart illustrating an example of a flow of processing related to the first usage example of the degree of similarity DS according to the present embodiment. The processing of this flowchart is executed by, for example, the management apparatus 30 (processor 32). The processing is started in response to the start of remote support, for example.

In step S200, the management apparatus 30 determines whether or not there is a task T completed among the plurality of tasks T (hereinafter, referred to as a completed task Tc) included in the current remote support. This determination is made based on, for example, whether or not a positive answer indicating that a task T is completed has been received by the management apparatus 30. When there is a completed task Tc (step S200; Yes), the processing proceeds to step S202. On the other hand, when there is no completed task Tc (step S200; No), the processing proceeds to S208.

In step S202, the management apparatus 30 calculates a degree of similarity DS of the completed task Tc. The calculation of the degree of similarity DS can be performed by using, for example, a known video (image) recognition technique using a video feature amount extracted from the video V of the surrounding situation ST as a target of the determination in the completed task Tc. The calculated degree of similarity DS corresponds to the degree of similarity using, as a reference, the video V of the surrounding situation ST at the time of completion of the completed task Tc, that is, the degree of similarity of the video V of the current surrounding situation ST with respect to the reference video V.

In step S204 subsequent to step S202, the management apparatus 30 determines whether or not the calculated degree of similarity DS is lower than a designated threshold value. As a result, when the degree of similarity DS is decreased (step S204; Yes), the processing proceeds to step S206. On the other hand, when the degree of similarity DS is not lower than the threshold value (step S204; No), the processing proceeds to step S208.

In step S206, the management apparatus 30 requests the remote supporter to re-execute the completed task Tc whose degree of similarity DS has decreased, through the remote support device 20. More specifically, for example, the management apparatus 30 corrects the execution order O such that the completed task Tc is executed again after the plurality of tasks T are completed in accordance with the original execution order O. In addition, when the degree of similarity DS of the completed task Tc is not lower than the threshold value, the management apparatus 30 does not request the remote supporter to re-execute the completed task Tc.

In step S208, the management apparatus 30 determines whether or not the current remote support is completed. This determination is made based on, for example, whether or not all the tasks T have been completed without the degree of similarity DS falling below the threshold value. As a result, when the remote support is not completed (step S208; No), the processing of steps S200 to S206 is repeatedly executed every time the individual task T is completed. On the other hand, when the remote support is completed (step S208; Yes), the processing proceeds to END.

According to the first usage example, it is possible to appropriately reduce the re-execution of the task T by using the degree of similarity DS. In addition, it is possible to reduce the load on the remote supporter while favorably securing the reliability (i.e., temporal validity) of the determination result of the remote supporter for each task T.

### Second Usage Example

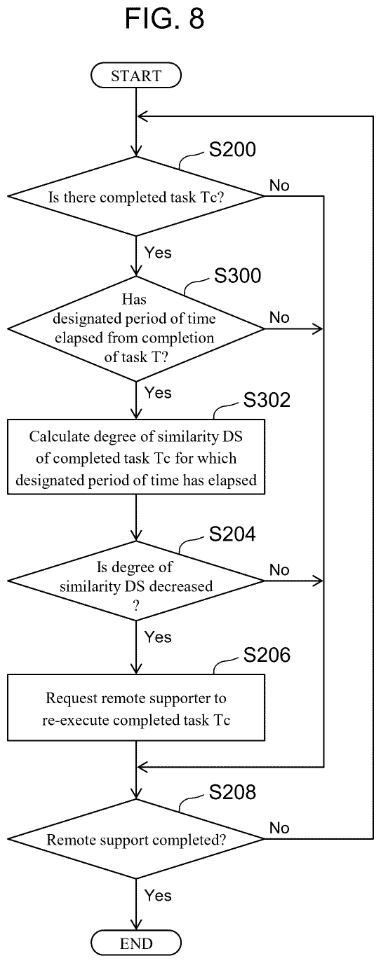

FIG. 8 is a flowchart illustrating an example of a flow of processing related to the second usage example of the degree of similarity DS according to the present embodiment. The processing of this flowchart is different from the processing of the flowchart shown in FIG. 7 in the following points.

In FIG. 8, when there is a completed task Tc (step S200; Yes), the processing proceeds to step S300. In step S300, the management apparatus 30 determines whether or not a designated period of time has elapsed from the completion of the completed task Tc. The ease with which the degree of similarity DS decreases may vary depending on the content of the task T. Therefore, the designated period of time may be determined for each task T. When the designated period of time has elapsed (step S300; Yes), the processing proceeds to step S302. On the other hand, when the designated period of time has not elapsed (step S300; No), the processing proceeds to step S208. That is, if the designated period of time has not elapsed, the degree of similarity DS is not calculated even when the completed task Tc exists.

In step S302, the management apparatus 30 calculates a degree of similarity DS of the completed task Tc for which the designated period of time has elapsed. Even in step S302, the calculated degree of similarity DS corresponds to the degree of similarity of the video V of the current surrounding situation ST with respect to the video V of the surrounding situation ST at the time of completion of the completed task Tc. Thereafter, the processing proceeds to step S204.

According to the second usage example, the time when the determination of the degree of similarity DS is necessary is specified and the degree of similarity DS is then calculated (see steps S300 and S302). This makes it possible to obtain the same effect as that of the first usage example while reducing the calculation load of the degree of similarity DS.

### 4-2. Determination of Execution Order of Tasks

In order to determine the execution order O of a plurality of tasks T, the degree of similarity DS of the surrounding situation ST may be used as follows, for example. That is, the execution order database (see step S104) indicating the correspondence between the plurality of tasks T and the execution order O may be configured such that the execution order O of a task T for which the degree of similarity DS is easily calculated (determined) is earlier than the execution order O of a task T for which the degree of similarity DS is not easily calculated (determined).

The time from the completion of the task T to the completion of the remote support is longer in a task T whose execution order O is earlier than in the task T whose execution order O is later. Therefore, regarding the task T whose execution order O is earlier, an opportunity to calculate the degree of similarity DS for the determination of necessity of re-execution of the task T (see Section 4-1) is likely to occur. According to the example of determining the execution order O described here, the degree of similarity DS related to the task T in which the opportunity of the calculation is likely to occur is easily determined, and thus it is possible to appropriately determine the necessity of re-execution of the task T.

An example of the remote support to which the determination example described here is applied is as follows. That is, in an example of the remote support for a right turn of the vehicle 10 having “a task T1 for confirming that an arrow signal for the right turn is displayed” and “a task T2 for confirming that there is no oncoming vehicle obstructing the right turn” as a plurality of tasks T, it can be said that determining the change of the signal display of the traffic signal (i.e., signal recognition) using the degree of similarity DS is easier than recognizing the oncoming vehicle which is traveling using the degree of similarity DS. Therefore, in this example, the execution order O is determined such that the task T1 is performed before the task T2.

What is claimed is:

1. A remote support system, comprising
processing circuitry configured to:
acquire a plurality of tasks which are obtained by being divided in accordance with content of remote support requested from an automated driving vehicle and an execution order of which is determined; and
execute display processing of displaying one or more videos necessary for execution of the plurality of tasks on a remote support device operated by a remote supporter such that the remote supporter is caused to perform the plurality of tasks in accordance with the execution order.

2. The remote support system according to claim 1, wherein
the one or more videos include a plurality of videos, and
in the display processing, the processing circuitry displays the plurality of videos one by one on a designated position of a screen of the remote support device in accordance with the execution order.

3. The remote support system according to claim 1, wherein
in the display processing, the processing circuitry displays an auxiliary display indicating the execution order on a screen of the remote support device.

4. The remote support system according to claim 1, wherein
the one or more videos include a plurality of videos,
the plurality of videos are videos of a plurality of surrounding situations of the automated driving vehicle that are captured by one or more cameras,
each of the plurality of tasks is for requesting the remote supporter to make a determination on a surrounding situation included in the plurality of surrounding situations, and
the processing circuitry is further configured to:
when a task included in the plurality of tasks is completed, calculate, using a time of completion of the completed task as a reference, a degree of similarity of the video of the surrounding situation that is a target of the determination in the completed task;
when the degree of similarity is lower than a threshold value, request the remote supporter through the remote support device to re-execute the completed task; and
when the degree of similarity is not lower than the threshold value, not request the remote supporter to re-execute the completed task.

5. The remote support system according to claim 1, wherein
the one or more videos include a plurality of videos,
the plurality of videos are videos of a plurality of surrounding situations of the automated driving vehicle that are captured by one or more cameras,
each of the plurality of tasks is for requesting the remote supporter to make a determination on a surrounding situation included in the plurality of surrounding situations, and
the processing circuitry is further configured to:
when, after a task included in the plurality of tasks is completed, a designated period of time elapses from completion of the completed task, calculate, using a time of completion of the completed task as a reference, a degree of similarity of the video of the surrounding situation that is a target of the determination in the completed task;
when the degree of similarity is lower than a threshold value, request the remote supporter through the remote support device to re-execute the completed task; and
when the degree of similarity is not lower than the threshold value, not request the remote supporter to re-execute the completed task.
